(19) United States
(12) Patent Application Publication
(10) Pub. No.: US 2021/0408739 A1
(43) Pub. Date: Dec. 30, 2021

(54) ADAPTERS FOR CONNECTING A CONNECTOR TO A CABLE TAP

(71) Applicant: PPC BROADBAND, INC., East Syracuse, NY (US)

(72) Inventors: Joshua C. IVANCIC, Clinton, NY (US); Noah P. MONTENA, Syracuse, NY (US); Doug JONES, East Syracuse, NY (US); Colin MCCONNELL, East Syracuse, NY (US); Daniel DAOUST, Syracuse, NY (US); Harold J. WATKINS, Chittenango, NY (US)

(73) Assignee: PPC BROADBAND, INC., East Syracuse, NY (US)

(21) Appl. No.: 17/364,271

(22) Filed: Jun. 30, 2021

Related U.S. Application Data
(60) Provisional application No. 63/046,686, filed on Jun. 30, 2020.
(60) Provisional application No. 63/086,030, filed on Sep. 30, 2020.

(51) Int. Cl. H01R 24/40; H01R 13/622; H01R 13/05

(52) U.S. Cl. CPC H01R 24/40; H01R 13/5202; H01R 13/052; H01R 13/622

(57) ABSTRACT

A tap adapter configured to removably couple a coaxial cable connector with a cable tap includes a body, a nut extending about the body, a retaining ring configured to couple the body with the nut, and a collet disposed in the body. The nut includes a first end configured to receive a coaxial cable connector. The collet has a first end configured to receive a center conductor of a cable terminated by the coaxial cable connector and a second end configured to be coupled with a port of a cable tap. The collet is configured to provide an electrical connection between the center conductor and the port of the cable tap. The nut is configured to rotate relative to the body and to slide axially relative to the body as limited by the retaining ring. The tap adapter permits the coaxial cable connector to be removed from the tap adapter while the tap adapter remains mechanically coupled with the cable tap and the second end of the collet remains mechanically and electrically coupled with the port.

### CROSS REFERENCE TO RELATED APPLICATIONS

This application claims the benefit of U.S. Provisional Application No. 63/046,686, filed Jun. 30, 2020, and U.S. Provisional Application No. 63/086,030, filed Sep. 30, 2020, the disclosures of which are hereby incorporated by reference herein in their entirety.

### TECHNICAL FIELD

The present disclosure relates to an adapter for connecting a connector to a cable tap device for use in the distribution of communication signals from a cable network, for a cable television (CATV) network, to a number of network subscribers.

### BACKGROUND

Cable taps are used to connect a number of subscribers in a local area into a cable television (CATV) network. A CATV network consists of interconnected coaxial cables and components such as repeating amplifiers, signal splitters, signal combiners, cable taps and other signal conveying devices to achieve two-way communication of signals between a network provider based at a “head-end” to a subscriber. Downstream signals from the provider to the subscriber are high frequency, typically within the frequency range 54-1002 MHz with return, or upstream, signals from the subscriber to the head-end in a non-overlapping frequency band, typically 5-42 MHz. In the CATV network, amplifiers and cable taps are positioned so that amplifiers compensate for signal loss of the coaxial cable and passive components such as the taps located along the cable path. To increase speed of signals throughout the network, the frequency range or bandwidth of signals can be increased. However, as higher frequencies are sent over the coaxial cable, the loss characteristics of components and the insertion loss of the coaxial cable alter producing more signal loss or less signal gain at higher frequencies.

A tap is a passive electronic device used to distribute television signals. The tap is used to “tap off” a part of the available signal and send it to a TV or multiple TV's. Taps are directional (Directional Coupler) to prevent unwanted signals from being fed backwards in a system. Taps are available in one, two, four eight and twelve port models. Taps have an input port and an output port (or ports). Depending on tap value, the tap port will tap from 3 dB to 32 dB off from the input level while only reducing the output level from 3 dB to 0.7 dB. This is what makes taps very efficient in distributing TV signals.

When technicians need to remove a connector from a tap in the field, the connector needs to be removed from the cable to do so. This disrupts the connection and forces the technician to re-prep and install the connector on the cable. This is very timely and potentially allows for additional errors to be made. The technician also needs to remove a dust cap and loosen a set screw to remove the connector. This creates more opportunities for the technician to either forget to reinstall these components or to damage components by not doing so in the correct process, which then can result in poor performance Technicians noted the difficulty of having to remove the connector from the cable to replace a tap.

Therefore, it is desirable to provide an adapter configured to facilitate quick and simple removal of a connector from a tap in the field without needing to remove the connector from the cable.

### SUMMARY

According to various aspects of the disclosure, a tap adapter configured to removably couple a coaxial cable connector with a cable tap includes a body, a nut extending about and arranged coaxially with the body, a retaining ring disposed radially between the body and the nut, and a collet disposed in the body. The retaining ring is configured to couple the body with the nut. The nut includes a first end configured to receive a coaxial cable connector, and the body is configured to extend from a second end of the nut. The collet has a first end configured to receive a center conductor of a cable terminated by the coaxial cable connector and a second end configured to be coupled with a port of a cable tap. The collet is configured to provide an electrical connection between the center conductor and the port of the cable tap and is electrically insulated from the body. The nut is free to rotate relative to the body and is free to slide axially relative to the body as limited by the retaining ring. The tap adapter permits the coaxial cable connector to be removed from the tap adapter while the tap adapter remains mechanically coupled with the cable tap and the second end of the collet remains mechanically and electrically coupled with the port.

In some embodiments, the second end of the collet includes an electrical contact member configured to be coupled with the port of the cable tap. According to some aspects, the electrical contact member is a flexible contact member. In some aspects, the electrical contact member is configured to be biasingly urged into contact with the port of the cable tap.

In various embodiments, the adapter further includes an insulator disposed in the body and configured to receive a portion of the collet, and the insulator is configured to electrically insulate the collet relative to the body.

In some embodiments, the body and the retaining ring comprise a conductive material configured to provide electrical grounding between the coaxial cable connector and the cable tap. In various aspects, the swivel nut comprises a conductive material.

According to some embodiments, the electrical contact member is a threaded contact member configured to be threadedly coupled with the port of the cable tap. In some aspects, the body is configured to be threadedly coupled with the cable tap, and a pitch of threads of the body is different than a pitch of threads of the electrical contact member. According to various aspects, the collet is configured to slide relative to the body such that electrical contact member of the collet is configured to be threadedly coupled with the port of the cable tap when body is threadedly coupled with the cable tap despite the different pitches of the threads of the body and the threads of the electrical contact member.

According to various aspects of the disclosure, a tap adapter configured to removably couple a coaxial cable connector with a cable tap includes a body, a nut extending about the body, a retaining ring configured to couple the body with the nut, and a collet disposed in the body. The nut includes a first end configured to receive a coaxial cable connector. The collet has a first end configured to receive a center conductor of a cable terminated by the coaxial cable connector and a second end configured to be coupled with a port of a cable tap. The collet is configured to provide an electrical connection between the center conductor and the port of the cable tap. The nut is configured to rotate relative to the body and to slide axially relative to the body as limited by the retaining ring. The tap adapter permits the coaxial cable connector to be removed from the tap adapter while the tap adapter remains mechanically coupled with the cable tap and the second end of the collet remains mechanically and electrically coupled with the port.

In some embodiments, the second end of the collet includes an electrical contact member configured to be coupled with the port of the cable tap. According to some aspects, the electrical contact member is a flexible contact member. In some aspects, the electrical contact member is configured to be biasingly urged into contact with the port of the cable tap.

In various embodiments, the adapter further includes an insulator disposed in the body and configured to receive a portion of the collet, and the insulator is configured to electrically insulate the collet relative to the body.

In some embodiments, the body and the retaining ring comprise a conductive material configured to provide electrical grounding between the coaxial cable connector and the cable tap. In various aspects, the swivel nut comprises a conductive material.

According to some embodiments, the electrical contact member is a threaded contact member configured to be threadedly coupled with the port of the cable tap. In some aspects, the body is configured to be threadedly coupled with the cable tap, and a pitch of threads of the body is different than a pitch of threads of the electrical contact member. According to various aspects, the collet is configured to slide relative to the body such that electrical contact member of the collet is configured to be threadedly coupled with the port of the cable tap when body is threadedly coupled with the cable tap despite the different pitches of the threads of the body and the threads of the electrical contact member.

The foregoing and other features of construction and operation of the invention will be more readily understood and fully appreciated from the following detailed disclosure, taken in conjunction with accompanying drawings.

### BRIEF DESCRIPTION OF THE DRAWINGS

FIG. 1 is a perspective view of an exemplary swivel tap adapter in accordance with various aspects of the disclosure coupled with an exemplary cable tap device.

FIG. 2 is a perspective view of the swivel tap adapter of FIG. 1.

FIG. 3 is a side cross-sectional view of the swivel tap adapter of FIG. 1.

FIG. 4 is a side cross-sectional view of the swivel tap adapter of FIG. 1 coupled with the exemplary tap device and an exemplary hardline cable connector.

FIG. 5 is a perspective view of another exemplary swivel tap adapter in accordance with various aspects of the disclosure.

FIG. 6 is a side cross-sectional view of the swivel tap adapter of FIG. 5 coupled with the exemplary tap device.

FIG. 7 is a perspective view of another exemplary swivel tap adapter in accordance with various aspects of the disclosure coupled with the exemplary cable tap device.

FIG. 8 is a side cross-sectional view of the exemplary swivel tap adapter of FIG. 7 of coupled with the exemplary cable tap device.

FIG. 9 is a perspective view of another exemplary swivel tap adapter in accordance with various aspects of the disclosure.

FIG. 10 is a side cross-sectional view of the swivel tap adapter of FIG. 9.

FIG. 11 is a perspective cross-sectional view of another exemplary swivel tap adapter in accordance with various aspects of the disclosure coupled with the exemplary tap device.

FIG. 12 is a side cross-sectional view of the swivel tap adapter of FIG. 11 coupled with the exemplary tap device.

FIG. 13 is a perspective view of the exemplary collet of the swivel tap adapter of FIG. 11.

FIG. 14 is a side cross-sectional view of another exemplary swivel tap adapter in accordance with various aspects of the disclosure.

FIG. 15 is a side cross-sectional view of the swivel tap adapter of FIG. 11 coupled with the exemplary tap device in a first position.

FIG. 16 is a side cross-sectional view of the swivel tap adapter of FIG. 11 coupled with the exemplary tap device in a second position.

### DETAILED DESCRIPTION OF EMBODIMENTS

As a preface to the detailed description, it should be noted that, as used in this specification and the appended claims, the singular forms “a”, “an” and “the” include plural referents, unless the context clearly dictates otherwise.

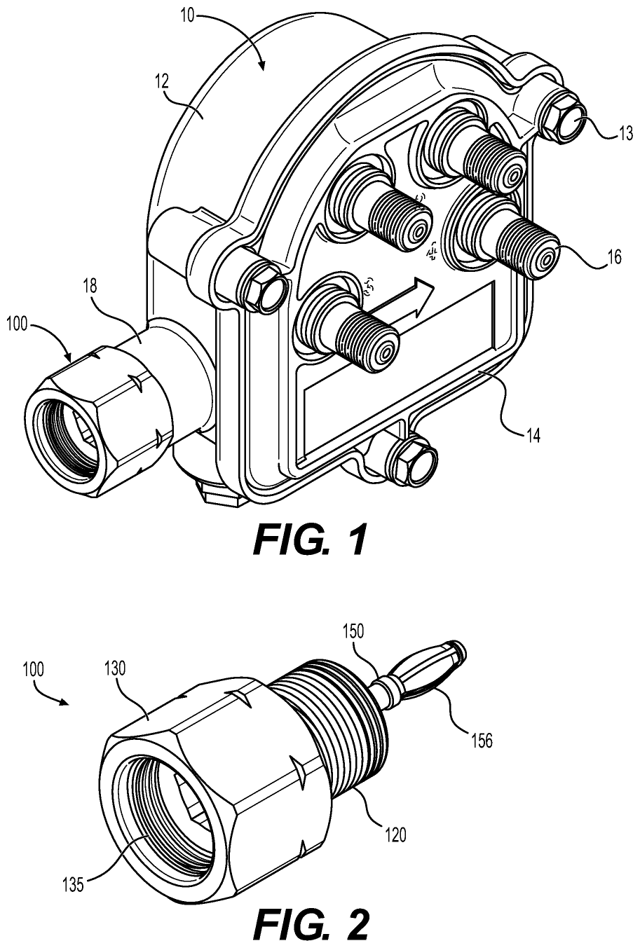

Referring to FIGS. 1-4, an exemplary swivel tap adapter 100 in accordance with various aspects of the disclosure is illustrated and described. FIG. 1 shows the swivel tap adapter 100 coupled with a cable tap device 10. The cable tap device 10 comprises a rear section being a back plate or back-box 12 connected to face plate 14 having a plurality of cable taps or tap ports 16. The back-box 12 and the face plate 14 may be secured together with fasteners 13. In use within a CATV network, signals sent along a main cable (not shown) and routed through the back-box 12 via an input port 18 are accessed by users connected to the tap ports 16 by drop cables. In some aspects, the cable tap device 10 may include an amplifier unit when noise levels within the network become such that signals cannot be supported and further amplification is required. By having a self-contained amplifier unit that can be positioned between the face plate and the back-box, the amplifier unit can be used to increase the signal level and so allow the signal transfer characteristics associated with a cable tap unit to be upgraded as and when required without the need to replace or re-site the tap unit.

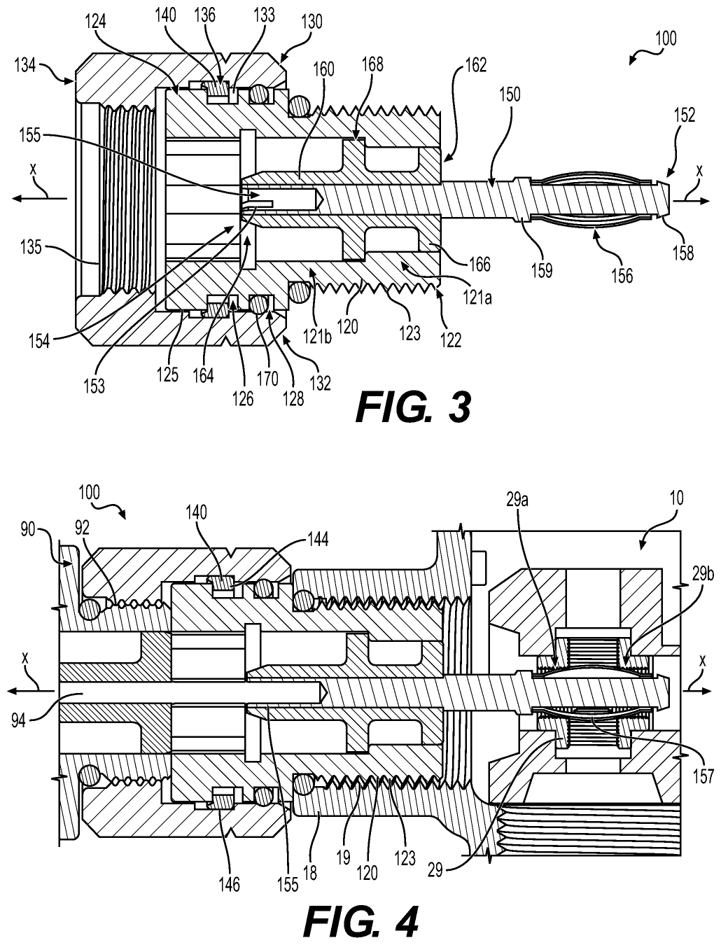

Referring now to FIGS. 2 and 3, the swivel tap adapter 100 includes a body 120, a swivel nut 130, a retaining ring 140, a collet 150, and an insulator 160. The body 120, the swivel nut 130, and the retaining ring 140 comprise a conductive material configured to provide electrical grounding with the input port 18 of the cable tap device 10. The body 120 and the swivel nut 130 are arranged coaxially with one another along a longitudinal axis X of the swivel tap adapter 100, and the retaining ring 140 is configured to couple the body 120 with the swivel nut 130. The body 120 includes a threaded first end 122 and a flanged second end 124. The threaded first end 122 may include a threaded outer surface 123 configured to be threadedly received by a threaded inner surface 19 of the input port 18 of the cable tap device 10, as shown in FIG. 4. The flanged second end 124 includes an outer surface 125 having a first annular groove 126 configured to receive the retaining ring 140, as will be discussed in more detail below, and a second annular groove 128 configured to receive a sealing member 170, for example, an O-ring. As illustrated in FIGS. 3 and 4, the second annular groove 128 is between the first annular groove 126 and the threaded first end 122 in a direction of the longitudinal axis X.

The swivel nut 130 includes a first end 132 having an inner diameter sized to slidingly and rotatingly receive the second end 124 of the body 120. That is, the swivel nut 130 is free to rotate relative to the body 120 and is free to slide relative to the body 120 as limited by the retaining ring 140, as discussed in more detail below. The first end 132 of the swivel nut 130 includes an inner surface 133 having an annular groove 136 configured to receive the retaining ring 140, as will be discussed in more detail below. The swivel nut 130 includes a second end 134 having an inner diameter that is smaller than an outer diameter of the body 120 such that the body 120 cannot be moved through the second end 134 of the swivel nut 130. The second end 134 may include a threaded inner surface 135 configured to threadedly receive a coaxial cable connector 90, for example, a hardline cable connector, having an exterior threaded surface 92.

As illustrated in FIGS. 3 and 4, the first annular groove 126 of the body 120 is configured to at least partly overlap the annular groove 136 of the swivel nut 130 along the longitudinal axis X when the body 120 and the swivel nut 130 are assembled together, and the retaining ring 140 is received in the first annular groove 126 of the body 120 and the annular groove 136 of the swivel nut 130. For example, the retaining ring 140 has a radial thickness selected such that an inner surface 142 of the retaining ring 140 has an inner diameter that is less than an outer diameter of the second end 124 of the body 120 but greater than an outer diameter of the first annular groove 126 such that an inner portion 144 of the retaining ring 140 is received in the first annular groove 126. The radial thickness is also selected such that an outer surface 146 of the retaining ring 140 has an outer diameter than is greater than an inner diameter of the first end 132 of the swivel nut 130 but less than an inner diameter of the annular groove 136 of the swivel nut 130 such than an outer portion 148 of the retaining ring 140 is received in the annular groove 136. Meanwhile, a dimension of the retaining ring 140 in the direction of the longitudinal axis X is less than a longitudinal dimension of the first annular groove 126 and a longitudinal dimension of the annular groove 136. Thus, the swivel nut 130 is axially slidable relative to the body 120 within limits provided by the longitudinal dimensions of the retaining ring 140, the first annular groove 126, and the annular groove 136.

The insulator 160 is configured to be received in the body 120 and to receive a portion of the collet 150 and includes a first end 162 and a second end 164. The insulator 160 comprises a dielectric material that electrically insulates the collet 150 relative to the body 120. For example, as shown in FIGS. 3 and 4, the insulator 160 includes a first annular flange 166 at the first end 162 of the insulator 160 and a second annular flange 168 intermediate the first and second ends 162, 164. Meanwhile, the first end 122 of the body 120 may include a first portion 121a having a smaller inner diameter than a second portion 121b of the first end 122. The second annular flange 168 may have a greater diameter than the first annular flange 166 and greater than the first portion 121a of the first end 122 of the body 120 such that the insulator 160 can be inserted and removed from the second end 124 of the body 120, but is prevented from being removed from the first end 122 of the body 120.

The collet 150 includes a first end 152 configured to be coupled with a set screw port 29 associated with the input port 18 of the cable tap device 10 and a second end 154 having a bore 155 configured to receive a center conductor 94 of the coaxial cable connector 90. The collet 150 comprises a conductive material configured to provide electrical connectivity with set screw port 29. The center conductor 94 can be a center conductor of a coaxial cable or a conductive pin of the coaxial cable connector 90. The bore 155 may have an inner diameter that is less than an outer diameter of the center conductor 94, and the second end 154 may include longitudinal slots 153 that permit the second end 154 to be urged radially outward to receive and retain the center conductor 94. The collet 150 includes a flexible contact member 156 extending radially outward at the first end 152 between a first flanged region 158 at the first end 152 and a second flanged region 159 intermediate the first and second ends 152, 154. The first and second flanged regions 158, 159 define shoulders than face one another, and the flexible contact member 156 is retained between the first and second flanged regions 158, 159. The second flanged region 159 includes a shoulder that faces in a direction of the second end 154 and is sized and configured to engage the first end 162 of the insulator 160 to prevent the second flanged region 159 from being inserted into the insulator 160.

The flexible contact member 156 may be sized and arranged such that at rest, the flexible contact member 156 has an outer diameter that is greater than an inner diameter of the set screw port 29. The flexible contact member 156 is configured to be urged radially inward by the set screw port 29. As shown in FIG. 4, the set screw port 29 includes first and second contact regions 29a, 29b spaced apart in the direction of the longitudinal axis X. The flexible contact member 156 may include a convex shape configured to be radially compressed as the flexible contact member 156 is inserted through the first contact region 29a and return toward its rest configuration as a center region 157 of the flexible contact member 156 is between the first and contact regions 29a, 29b. This arrangement may provide a technician with a tactile indication as to when the center region 157 of the flexible contact member 156 is between first and second contact regions 29a, 29b because the force required to insert the contact member 156 further and to withdraw the contact member 156 from the set screw port 29 is increased due to the outwardly biased center region 157.

In use, the swivel tap adapter 100 is coupled with the cable tap device 10 by threadedly coupling the first end 122 of the body 120 with the input port 18 of the cable tap device 10. Meanwhile, the flexible contact member 156 is electrically coupled with the contact regions 29a, 29b of the set screw port 29. The center conductor 194 of the coaxial cable connector 90 is then inserted into the collet 150 as the coaxial cable connector 90 is placed in proximity to the second end 134 of the swivel nut 130. The treaded surface 92 of the coaxial cable connector 90 is inserted into the second end 134 of the swivel nut 130, and the swivel nut 130 is rotated in a first direction relative to the body 120 of the swivel tap adapter 100 to threadedly couple the swivel nut 130 with the threaded surface 92 of the coaxial cable connector 90 to a desired tightening torque. If it is desired to remove the coaxial cable connector 90 from the cable tap device 10, the swivel nut 130 is rotated in a second direction relative to the body 120 of the swivel tap adapter 100, opposite to the first direction, to de-couple the swivel nut 130 from the threaded surface 92 of the coaxial cable connector 90.

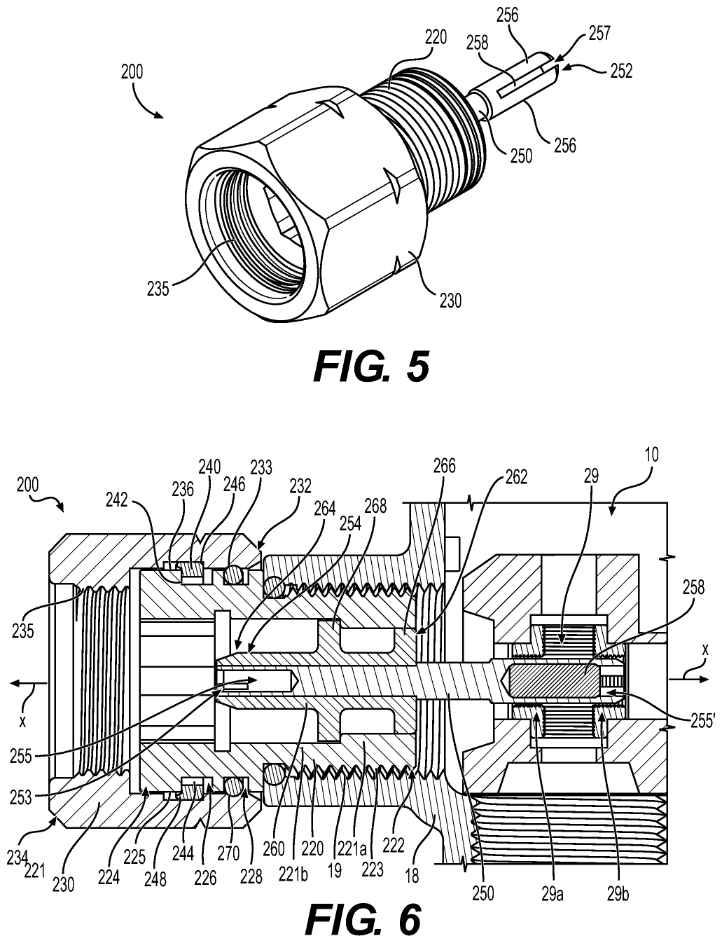

Referring now to FIGS. 5 and 6, an exemplary swivel tap adapter 200 in accordance with various aspects of the disclosure is illustrated and described. FIG. 6 shows the swivel tap adapter 200 coupled with the cable tap device 10 described above. The swivel tap adapter 200 includes a body 220, a swivel nut 230, a retaining ring 240, a collet 250, and an insulator 260. The body 220, the swivel nut 230, and the retaining ring 240 comprise a conductive material configured to provide electrical grounding with the input port 18 of the cable tap device 10. The body 220 and the swivel nut 230 are arranged coaxially with one another along a longitudinal axis X of the swivel tap adapter 200, and the retaining ring 240 is configured to couple the body 220 with the swivel nut 230. The body 220 includes a threaded first end 222 and a flanged second end 224. The threaded first end 222 may include a threaded outer surface 223 configured to be threadedly received by a threaded inner surface 19 of the input port of the cable tap device, as shown in FIG. 6. The flanged second end 224 includes an outer surface 225 having a first annular groove 226 configured to receive the retaining ring 240, as will be discussed in more detail below, and a second annular groove 228 configured to receive a sealing member 270, for example, an O-ring. As illustrated in FIG. 6, the second annular groove 228 is between the first annular groove 226 and the threaded first end 222 in a direction of the longitudinal axis X.

The swivel nut 230 includes a first end 232 having an inner diameter sized to slidingly and rotatingly receive the second end 224 of the body 220. That is, the swivel nut 230 is free to rotate relative to the body 220 and is free to slide relative to the body 220 as limited by the retaining ring 240, as discussed in more detail below. The first end 232 of the swivel nut 230 includes an inner surface 233 having an annular groove 236 configured to receive the retaining ring 240, as will be discussed in more detail below. The swivel nut 230 includes a second end 234 having an inner diameter that is smaller than an outer diameter of the body 220 such that the body 220 cannot be moved through the second end 234 of the swivel nut 230. The second end 234 may include a threaded inner surface 235 configured to threadedly receive a coaxial cable connector 90, for example, a hardline cable connector, having an exterior threaded surface 92.

As illustrated in FIG. 6, the first annular groove 226 of the body 220 is configured to at least partly overlap the annular groove 236 of the swivel nut 230 along the longitudinal axis X when the body 220 and the swivel nut 230 are assembled together, and the retaining ring 240 is received in the first annular groove 226 of the body 220 and the annular groove 236 of the swivel nut 230. For example, the retaining ring 240 has a radial thickness selected such that an inner surface 242 of the retaining ring 240 has an inner diameter that is less than an outer diameter of the second end 224 of the body 220 but greater than an outer diameter of the first annular groove 226 such that an inner portion 244 of the retaining ring 240 is received in the first annular groove 226. The radial thickness is also selected such that an outer surface 246 of the retaining ring 240 has an outer diameter than is greater than an inner diameter of the first end 232 of the swivel nut 230 but less than an inner diameter of the annular groove 236 of the swivel nut 230 such than an outer portion 248 of the retaining ring 240 is received in the annular groove 236. Meanwhile, a dimension of the retaining ring 240 in the direction of the longitudinal axis X is less than a longitudinal dimension of the first annular groove 226 and a longitudinal dimension of the annular groove 236. Thus, the swivel nut 230 is axially slidable relative to the body 220 within limits provided by the longitudinal dimensions of the retaining ring 240, the first annular groove 226, and the annular groove 236.

The insulator 260 is configured to be received in the body 220 and to receive a portion of the collet 250 and includes a first end 262 and a second end 264. The insulator 260 comprises a dielectric material that electrically insulates the collet 250 relative to the body 220. For example, as shown in FIG. 6, the insulator 260 includes a first annular flange 266 at the first end 262 of the insulator 260 and a second annular flange 268 intermediate the first and second ends 262, 264. Meanwhile, the first end 222 of the body 220 may include a first portion 221a having a smaller inner diameter than a second portion 221b of the first end 222. The second annular flange 268 may have a greater diameter than the first annular flange 266 and greater than the first portion 221a of the first end 222 of the body 220 such that the insulator 260 can be inserted and removed from the second end 224 of the body 220, but is prevented from being removed from the first end 222 of the body 220.

The collet 250 includes a first end 252 configured to be coupled with a set screw port 29 associated with the input port 18 of the cable tap device 10 and a second end 254 having a bore 255 configured to receive a center conductor 94 of the coaxial cable connector 90. The collet 250 comprises a conductive material configured to provide electrical connectivity with set screw port 29. The center conductor 94 can be a center conductor of a coaxial cable or a conductive pin of the coaxial cable connector 90. The bore 255 may have an inner diameter that is less than an outer diameter of the center conductor 94, and the second end 254 may include longitudinal slots 253 that permit the second end 254 to be urged radially outward to receive and retain the center conductor 94. The first end 252 of the collet 250 includes flexible fingers 256 formed by longitudinal slots 257 in the first end 252 and an expansion member 258 held by the flexible fingers 256 in a bore 255′ at the first end 252 of the collet 250. An outer diameter of the expansion member 258 is greater than an inner diameter of the fingers 256 such that the fingers are configured to be biased outwardly by the expansion member 258. The outer surface of the collet 250 defines a shoulder that faces in a direction of the second end 254 and is sized and configured to engage the first end 262 of the insulator 260 to limit insertion of the collet 150 into the insulator 260.

The flexible fingers 256 may be sized and arranged such that while holding the expansion member 258, the flexible fingers 256 have an outer diameter that is greater than an inner diameter of the set screw port 29. The expansion member 258 may comprise an elastomeric material that is compressible, but is not compressible by a biasing force of the fingers 256 themselves. That is, the radially outward biasing force of the expansion member 258 on the fingers 256 is greater than the radially inward biasing force of the fingers 256 on the expansion member 258. However, when the swivel tap adapter 200 is coupled with the cable tap device 10, the flexible fingers 256 are configured to be urged radially inward by the set screw port 29, thereby radially compressing the expansion member 258. As shown in FIG. 6, the set screw port 29 includes first and second contact regions 29a, 29b spaced apart in the direction of the longitudinal axis X. The flexible fingers 256 are configured to be radially compressed as the flexible fingers 256 are inserted through the first and second contact regions 29a, 29b.

In use, the swivel tap adapter 200 is coupled with the cable tap device 10 by threadedly coupling the first end 222 of the body 220 with the input port 18 of the cable tap device 10. Meanwhile, the flexible fingers 256 are electrically coupled with the contact regions 29a, 29b of the set screw port 29. The center conductor 94 of the coaxial cable connector 90 is then inserted into the collet 250 as the coaxial cable connector 90 is placed in proximity to the second end 234 of the swivel nut 230. The threaded surface 92 of the coaxial cable connector 90 is inserted into the second end 234 of the swivel nut 230, and the swivel nut 230 is rotated in a first direction relative to the body 220 of the swivel tap adapter 200 to threadedly couple the swivel nut 230 with the threaded surface 92 of the coaxial cable connector 90 to a desired tightening torque. If it is desired to remove the coaxial cable connector 90 from the cable tap device 10, the swivel nut 230 is rotated in a second direction relative to the body 220 of the swivel tap adapter 200, opposite to the first direction, to de-couple the swivel nut 230 from the threaded surface 92 of the coaxial cable connector 90.

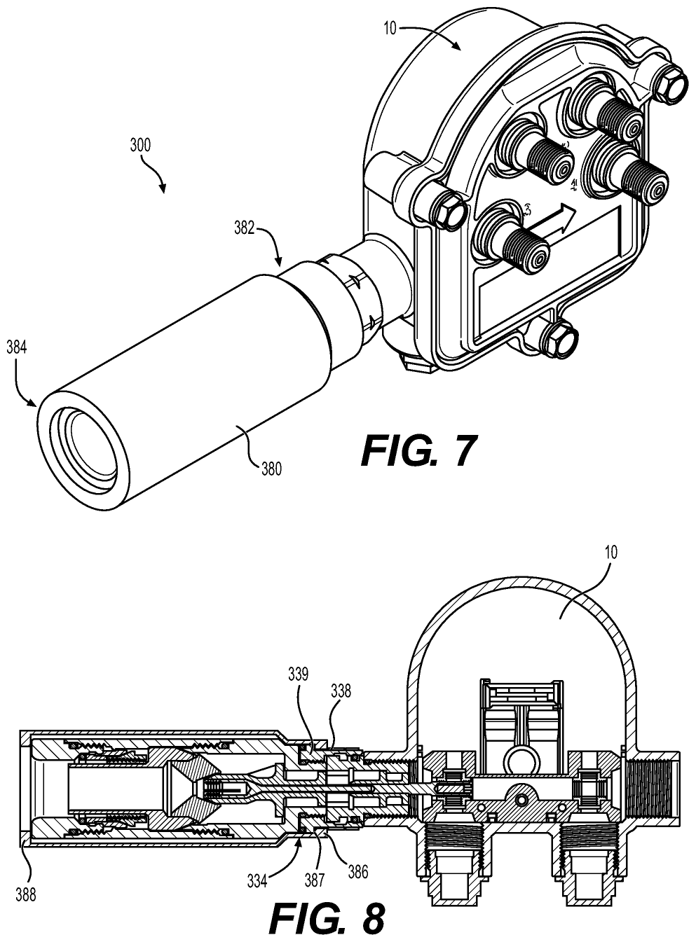

Referring now to FIGS. 7 and 8, another exemplary swivel tap adapter 300 in accordance with various aspects of the disclosure is illustrated and described. The swivel tap adapter 300 is relatively similar to the swivel tap adapter 200 discussed above, and FIGS. 7 and 8 show the swivel tap adapter 300 coupled with the cable tap device 10 described above. The swivel tap adapter 300 is different from the swivel tap adapter 200 in that a swivel nut 330 of the swivel tap adapter 300 includes an annular projection 339 extending radially outward from an outer surface 338 of the second end 334 of the swivel nut 330. It should be understood that the swivel tap adapter 300 may alternatively include one or more projections extending about a portion of the circumference of the second end 334 of the swivel nut 330.

The swivel tap adapter 300 also includes a protective boot 380 having a first end 382 and a second end 384. The boot 380 includes a first lip 386 that extends radially inward at the first end 382 and a second lip 388 that extends radially inward at the second end 384. The first lip 386 has an inner diameter that is less than an outer diameter of the annular projection 339. Thus, boot 380 can be assembled with the swivel nut 330 such that the first lip 386 includes a surface 387 that is configured to engage the projection 339 to inhibit removal of the boot 380 from the swivel nut 330. The inner diameter of the first lip 386 may also be less than an outer diameter of the second end 334 of the swivel nut 330 such that the boot 380 sealingly engages the outer surface of the swivel nut. The boot 380 is sized and arranged to cover and protect a coaxial cable connector 90, and the second lip 388 is configured to sealingly engage an outer surface of a cable, for example, a hardline coaxial cable, terminated by the connector 90.

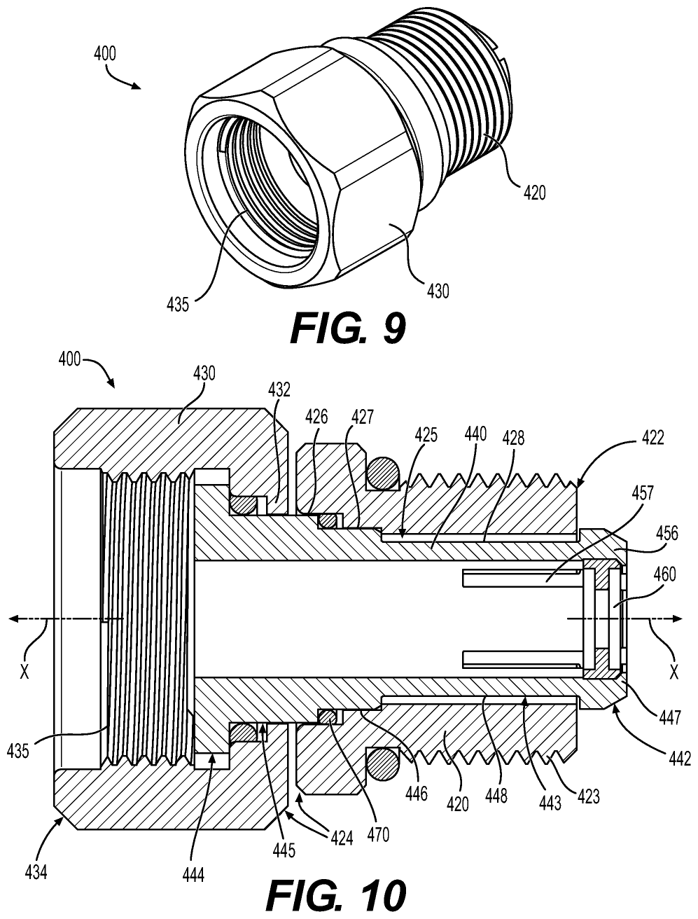

Referring now to FIGS. 9 and 10, yet another exemplary swivel tap adapter 400 in accordance with various aspects of the disclosure is illustrated and described. The swivel tap adapter 400 includes a body 420, a swivel nut 430, a retainer 440, and an insulator 460. The body 420, the swivel nut 430, and the retainer 440 comprise a conductive material configured to provide electrical grounding with the input port 18 of the cable tap device 10. The body 420 and the swivel nut 430 are arranged coaxially with one another along a longitudinal axis X of the swivel tap adapter 400, and the retainer 440 is configured to couple the body 420 with the swivel nut 430. The body 420 includes a threaded first end 422 and a flanged second end 424. The threaded first end 422 may include a threaded outer surface 423 configured to be threadedly received by a threaded inner surface 19 of the input port 18 of the cable tap device 10.

The body 420 includes an inner surface 425 having a first bore portion 426, a second bore portion 427, and a third bore portion 428. The first bore portion 426 has an inner diameter that is greater than an inner diameter of the second bore portion 427, and the inner diameter of the second bore portion 427 is greater than an inner diameter of the third bore portion 428. The retainer 440 includes a flanged first end 442 and a flanged second end 444. The first end 442 includes flexible fingers 456 formed by longitudinal slots 457 in the first end 442, and the insulator 460 is held by the flexible fingers 456 in the third bore portion 428 at the first end 422 of the body 420.

The retainer 440 has an outer surface 443 having a first outer diameter portion 445 extending from the second end 444 toward the first end 442 and a second outer diameter portion 446 extending from the first outer diameter portion 445 toward the first end 442. The second outer diameter portion 446 and the flanged first end 442 define an annular groove 448 therebetween. The annular groove 448 has an outer diameter that is less than an outer diameter of the second outer diameter portion 446 and an outer diameter portion of the flanged first end 442. The annular groove 448 has an axial dimension sized to receive the third bore portion 428 of the body 420 there between such that axial removal of the body 420 from the retainer 440 is inhibited.

An outer diameter of the insulator 460 is greater than an inner diameter of the fingers 456 such that the fingers are configured to be biased outwardly by the insulator 460. The inner surface of the retainer 440 defines a radially inward lip 447 at the flanged first end 442 that faces in a direction of the second end 444 of the retainer and is sized and configured to engage a first end 462 of the insulator 460 to inhibit the insulator 460 from being removed through the first end 442 of the retainer 440.

The flexible fingers 456 may be sized and arranged such that while holding the insulator 460, the flexible fingers 456 at the first end 442 of the retainer 440 have an outer diameter that is greater than the third bore portion 428 of the body 420. The insulator 460 may comprise an elastomeric material that is compressible, but is not compressible by a biasing force of the fingers 456 themselves. That is, the radially outward biasing force of the insulator 460 on the fingers 456 is greater than the radially inward biasing force of the fingers 456 on the insulator 460. However, when the retainer 440 is insertingly coupled with the body 420, the flexible fingers 456 are configured to be urged radially inward by the inner surface of the third bore portion 428 of the body 420, thereby radially compressing the insulator 460 until the flanged first end 442 of the retainer 440 exits the first end 422 of the body 420. The insulator 460 has an inner surface configured to receive and grip an outer surface of a cable, for example, a hardline coaxial cable while allowing the center conductor 94 of the cable to pass through the adapter 400 and into the set screw port 29 of the cable tap device 10 where the center conductor 94 can be urged into electrical grounding contact with the contact regions 29a, 29b of the set screw port 29 by a set screw (not shown), as would be understood by persons skilled in the art.

The swivel nut 430 includes a flanged first end 432 and a second end 434 having a threaded inner surface 435 configured to threadedly receive a coaxial cable connector 90, for example, a hardline cable connector, having an exterior threaded surface 92. The flanged first end 432 of the swivel nut 430 has an inner diameter that is smaller than an outer diameter of the flanged second end 444 of the retainer 440 such that the swivel nut 430 cannot be moved from the second end 444 of the retainer 440. The inner diameter of the flanged first end 432 of the swivel nut 430 is sized to slidingly and rotatingly receive the first outer diameter portion 445 of the retainer 440. That is, the swivel nut 430 is free to rotate relative to the retainer 440 and the body 420 and is free to slide relative to the retainer 440 as limited by the second end 424 of the body and the flanged second end 444 of the retainer 440.

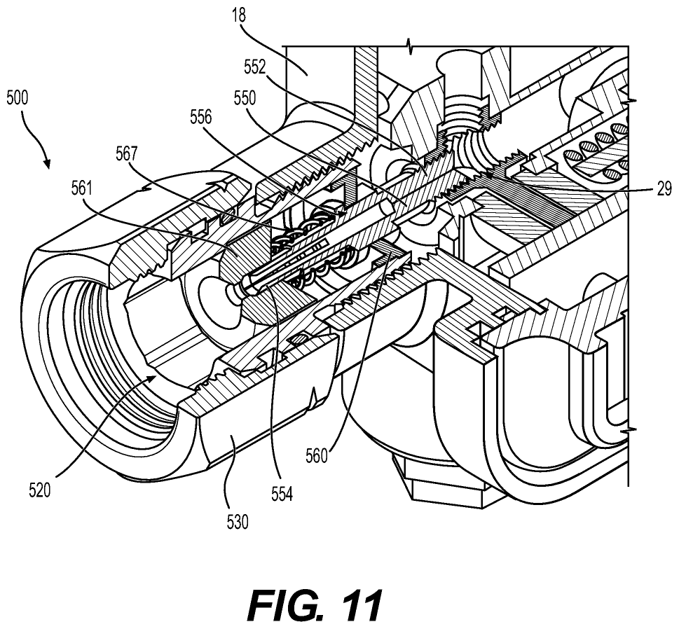

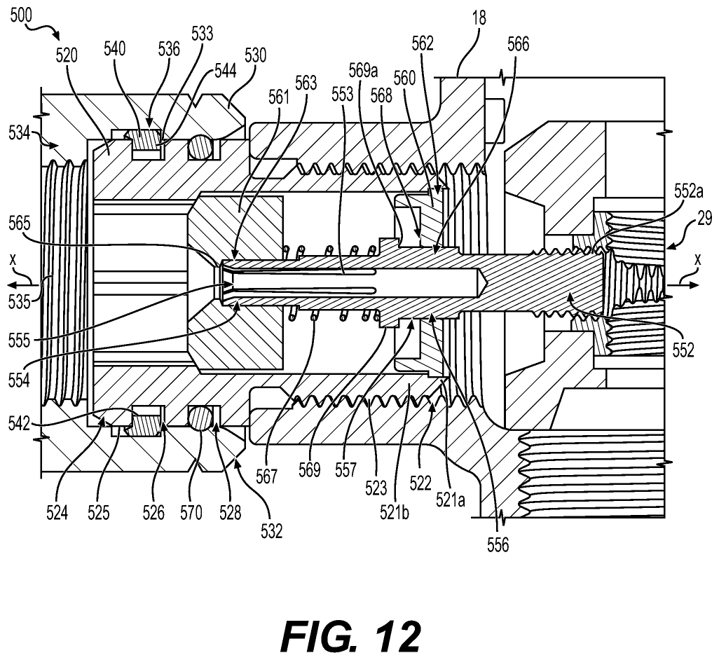

Referring now to FIGS. 11-13, another exemplary swivel tap adapter 500 in accordance with various aspects of the disclosure is illustrated and described. FIGS. 11 and 12 show the swivel tap adapter 500 coupled with the cable tap device 10 described above. The swivel tap adapter 500 includes a body 520, a swivel nut 530, a retaining ring 540, a collet 550, a first insulator 560, and a second insulator 561. The body 520, the swivel nut 530, and the retaining ring 540 comprise a conductive material configured to provide electrical grounding with the input port 18 of the cable tap device 10. The body 520 and the swivel nut 530 are arranged coaxially with one another along a longitudinal axis X of the swivel tap adapter 500, and the retaining ring 540 is configured to couple the body 520 with the swivel nut 530. The body 520 includes a threaded first end 522 and a flanged second end 524. The threaded first end 522 may include a threaded outer surface 523 configured to be threadedly received by a threaded inner surface 19 of the input port of the cable tap device, as shown in FIGS. 11 and 12. The flanged second end 524 includes an outer surface 525 having a first annular groove 526 configured to receive the retaining ring 540, as will be discussed in more detail below, and a second annular groove 528 configured to receive a sealing member 570, for example, an O-ring. As illustrated, the second annular groove 528 is between the first annular groove 526 and the threaded first end 522 in a direction of the longitudinal axis X.

The swivel nut 530 includes a first end 532 having an inner diameter sized to slidingly and rotatingly receive the second end 524 of the body 520. That is, the swivel nut 530 is free to rotate relative to the body 520 and is free to slide relative to the body 520 as limited by the retaining ring 540, as discussed in more detail below. The first end 532 of the swivel nut 530 includes an inner surface 533 having an annular groove 536 configured to receive the retaining ring 540, as will be discussed in more detail below. The swivel nut 530 includes a second end 534 having an inner diameter that is smaller than an outer diameter of the body 520 such that the body 520 cannot be moved through the second end 534 of the swivel nut 530. The second end 534 may include a threaded inner surface 535 configured to threadedly receive a coaxial cable connector 90, for example, a hardline cable connector, having an exterior threaded surface 92.

As best illustrated in FIG. 12, the first annular groove 526 of the body 520 is configured to at least partly overlap the annular groove 536 of the swivel nut 530 along the longitudinal axis X when the body 520 and the swivel nut 530 are assembled together, and the retaining ring 540 is received in the first annular groove 526 of the body 520 and the annular groove 536 of the swivel nut 530. For example, the retaining ring 540 has a radial thickness selected such that an inner surface 542 of the retaining ring 540 has an inner diameter that is less than an outer diameter of the second end 524 of the body 520 but greater than an outer diameter of the first annular groove 526 such that an inner portion 544 of the retaining ring 540 is received in the first annular groove 526. The radial thickness is also selected such that an outer surface 546 of the retaining ring 540 has an outer diameter than is greater than an inner diameter of the first end 532 of the swivel nut 530 but less than an inner diameter of the annular groove 536 of the swivel nut 530 such than an outer portion 548 of the retaining ring 540 is received in the annular groove 536. Meanwhile, a dimension of the retaining ring 540 in the direction of the longitudinal axis X is less than a longitudinal dimension of the first annular groove 526 and a longitudinal dimension of the annular groove 536. Thus, the swivel nut 530 is axially slidable relative to the body 520 within limits provided by the longitudinal dimensions of the retaining ring 540, the first annular groove 526, and the annular groove 536.

The first insulator 560 and the second insulator 561 are configured to be received in the body 520 and to receive a portion of the collet 550. The first insulator 560 and the second insulator 561 comprise a dielectric material that electrically insulates the collet 550 relative to the body 520. The second end 524 of the body 520 may have a smaller inner diameter than a remainder of the body 520, and an outer diameter of the second insulator 561 may be greater than the inner diameter of the second end 524 such that the second insulator 561 can be inserted and removed from the first end 522 of the body 520, but is prevented from being removed from the second end 524 of the body 520 by a radially inward shoulder of the body 520. The first end 522 of the body 520 may include a first portion 521a having a greater inner diameter than a second portion 521b of the first end 522. The first insulator 560 includes a first portion 562 that is press fit into the first portion 521a of the first end 522, and a second portion 564 that is press fit into the second portion 521b of the first end such that the first insulator 560 is configured to rotate together with the body 520. The first portion 562 has an outer diameter that is greater than the inner diameter of the second portion 521b of the first end 522 such that the first portion 562 of the first insulator 560 cannot move beyond the first portion 521a of the body 520 in a direction toward the second end 524 of the body 520.

The collet 550 includes a first end 552 configured to be coupled with a set screw port 29 associated with the input port 18 of the cable tap device 10 and a second end 554 having a bore 555 configured to receive a center conductor 94 of the coaxial cable connector 90. The second end 554 of the collet 550 is configured to be received in a through bore 563 of the second insulator 561. The through bore 563 of the second insulator 561 permits the center conductor 94 to pass there through into the bore 555 of the collet 550. The bore 563 includes a neck portion 565 having an inner diameter that is less than an outer diameter of the second end 554 of the collet 550 such that the collet 550 can be inserted into and removed from the second insulator 561 from the first end 522 of the body 520, but is prevented from being removed from the second end 524 of the body 520.

The collet 550 comprises a conductive material configured to provide electrical connectivity with set screw port 29. The center conductor 94 can be a center conductor of a coaxial cable or a conductive pin of the coaxial cable connector 90. The bore 555 may have an inner diameter that is less than an outer diameter of the center conductor 94, and the second end 554 may include longitudinal slots 553 that permit the second end 554 to be urged radially outward to receive and retain the center conductor 94.

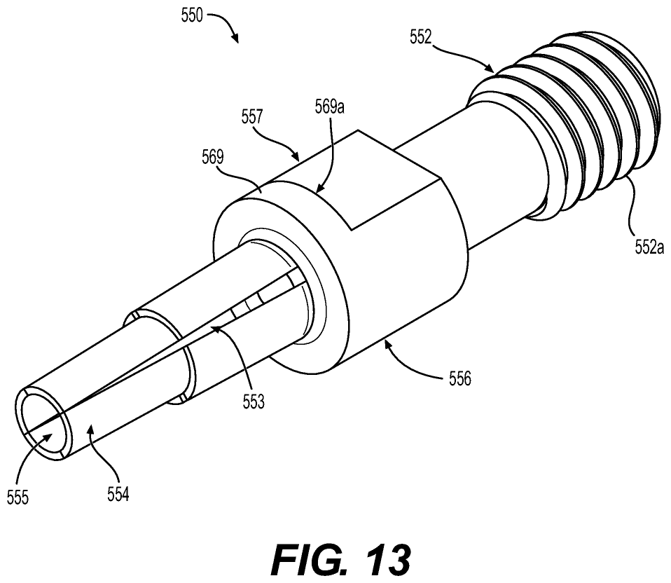

The first end 552 of the collet 550 includes external threads 552a configured to be threaded into the set screw port 29. The collet 550 includes a flanged middle portion 556 between the first end 552 and the second end 554 in the longitudinal direction X, as best illustrated in FIG. 13. The flanged middle portion 556 extends through a central through bore 566 of the first insulator 560. The flanged middle portion 556 has an outer surface that includes a keyed portion 557 configured to mate with a complementary keyed portion 568 of a through bore 566 of the first insulator 560 such that the collet 550 is configured to rotate with the first insulator 560, which in turn is configured to rotate with the body 520. Thus, the collet 550 is configured to rotate with the body 520. The keyed portion 568 of the flanged middle portion 556 is shaped and sized relative to the keyed portion 568 of the through bore 566 of the first insulator 560 such that the flanged middle portion 556 is axially translatable relative to the first insulator 560 and the body 520 in the longitudinal direction X.

The flanged middle portion 556 also includes a shoulder portion 569 between the first insulator 560 and the second insulator 562. The shoulder portion 569 has an outer diameter that is greater than an inner diameter of the keyed portion of the through bore 566 to prevent the flanged middle portion 556 from passing through the through bore 566 of the first insulator 560. The shoulder portion 569 includes a surface 569a that faces the second insulator 562. A resilient member 567, for example, a coil spring, is disposed between the surface 569a of the shoulder portion 569 and a facing surface 562a of the second insulator 562. The resilient member 567 maintains pressure on the surface 569a of the shoulder portion 569 to assist with threading of the external threads 556 with the set screw port 29 and maintaining electrical contact between the threads 556 and the set screw port 29. Further, as best illustrated in FIG. 12, the external threads 556 of the collet 550 and the threaded outer surface 523 of the first end 522 of the body 520 may have different thread pitches. The keyed configurations of the collet 550 and the first insulator 560 that permit axial translation between the collet 550 and the body 520 in the longitudinal direction X, combined with the resilient member 567 that urges the flanged middle portion 556 of the collet 550 toward the first insulator 560 facilitate threading of the external threads 556 into the set screw port 29 while the threaded outer surface 523 of the first end 522 of the body 520 is threaded into the input port 18 of the cable tap device 10.

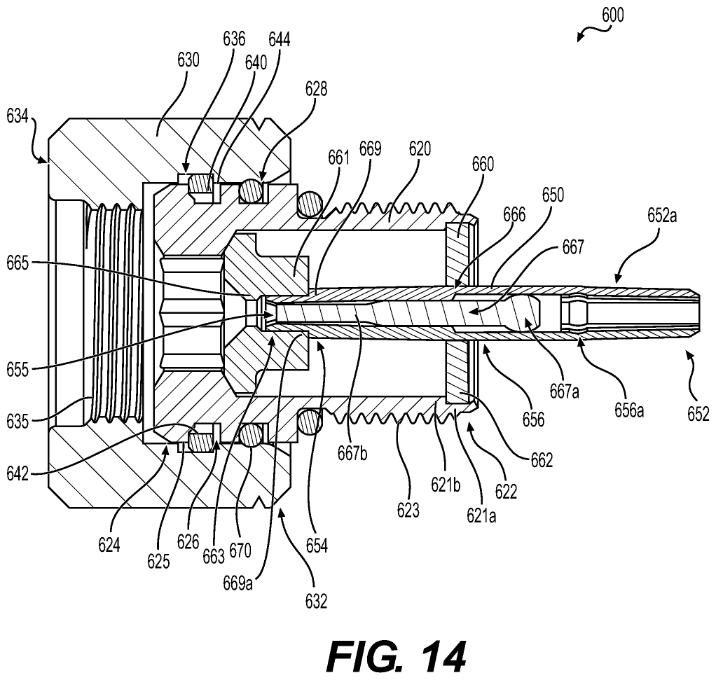

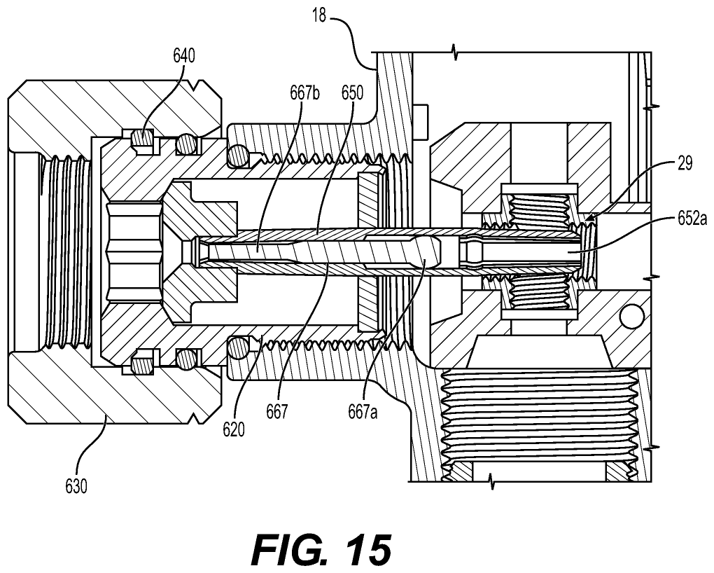

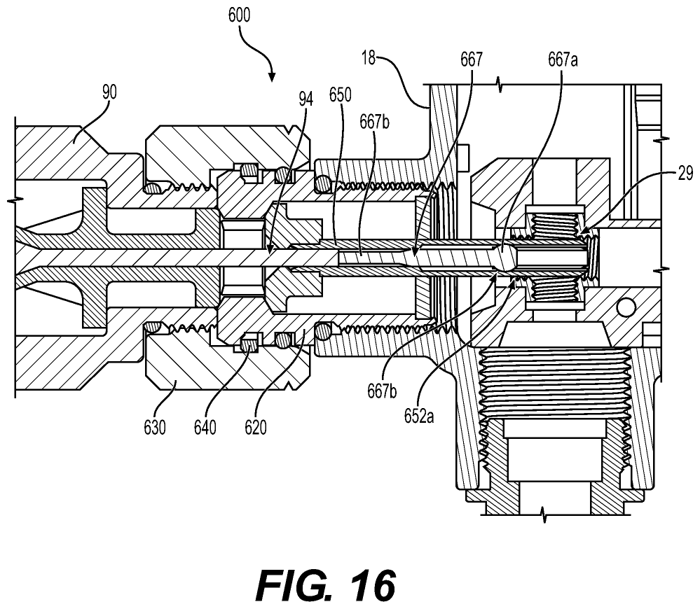

Referring now to FIGS. 14-16, another exemplary swivel tap adapter 600 in accordance with various aspects of the disclosure is illustrated and described. FIGS. 15 and 16 show the swivel tap adapter 600 coupled with the cable tap device 10 described above. The swivel tap adapter 600 includes a body 620, a swivel nut 630, a retaining ring 640, a external pin 650, a first insulator 660, and a second insulator 661. The body 620, the swivel nut 630, and the retaining ring 640 comprise a conductive material configured to provide electrical grounding with the input port 18 of the cable tap device 10. The body 620 and the swivel nut 630 are arranged coaxially with one another along a longitudinal axis X of the swivel tap adapter 600, and the retaining ring 640 is configured to couple the body 620 with the swivel nut 630. The body 620 includes a threaded first end 622 and a flanged second end 624. The threaded first end 622 may include a threaded outer surface 623 configured to be threadedly received by a threaded inner surface 19 of the input port of the cable tap device, as shown in FIGS. 15 and 16. The flanged second end 624 includes an outer surface 625 having a first annular groove 626 configured to receive the retaining ring 640, as will be discussed in more detail below, and a second annular groove 628 configured to receive a sealing member 670, for example, an O-ring. As illustrated, the second annular groove 628 is between the first annular groove 626 and the threaded first end 622 in a direction of the longitudinal axis X.

The swivel nut 630 includes a first end 632 having an inner diameter sized to slidingly and rotatingly receive the second end 624 of the body 620. That is, the swivel nut 630 is free to rotate relative to the body 620 and is free to slide relative to the body 620 as limited by the retaining ring 640, as discussed in more detail below. The first end 632 of the swivel nut 630 includes an inner surface 633 having an annular groove 636 configured to receive the retaining ring 640, as will be discussed in more detail below. The swivel nut 630 includes a second end 634 having an inner diameter that is smaller than an outer diameter of the body 620 such that the body 620 cannot be moved through the second end 634 of the swivel nut 630. The second end 634 may include a threaded inner surface 635 configured to threadedly receive a coaxial cable connector 90, for example, a hardline cable connector, having an exterior threaded surface 92.

As shown, the first annular groove 626 of the body 620 is configured to at least partly overlap the annular groove 636 of the swivel nut 630 along the longitudinal axis X when the body 620 and the swivel nut 630 are assembled together, and the retaining ring 640 is received in the first annular groove 626 of the body 620 and the annular groove 636 of the swivel nut 630. For example, the retaining ring 640 has a radial thickness selected such that an inner surface 642 of the retaining ring 640 has an inner diameter that is less than an outer diameter of the second end 624 of the body 620 but greater than an outer diameter of the first annular groove 626 such that an inner portion 644 of the retaining ring 640 is received in the first annular groove 626. The radial thickness is also selected such that an outer surface 646 of the retaining ring 640 has an outer diameter than is greater than an inner diameter of the first end 632 of the swivel nut 630 but less than an inner diameter of the annular groove 636 of the swivel nut 630 such than an outer portion 648 of the retaining ring 640 is received in the annular groove 636. Meanwhile, a dimension of the retaining ring 640 in the direction of the longitudinal axis X is less than a longitudinal dimension of the first annular groove 626 and a longitudinal dimension of the annular groove 636. Thus, the swivel nut 630 is axially slidable relative to the body 620 within limits provided by the longitudinal dimensions of the retaining ring 640, the first annular groove 626, and the annular groove 636.

The first insulator 660 and the second insulator 661 are configured to be received in the body 620 and to receive a portion of the external pin 650. The first insulator 660 and the second insulator 661 comprise a dielectric material that electrically insulates the external pin 650 relative to the body 620. The second end 624 of the body 620 may have a smaller inner diameter than a remainder of the body 620, and an outer diameter of the second insulator 661 may be greater than the inner diameter of the second end 624 such that the second insulator 661 can be inserted and removed from the first end 622 of the body 620, but is prevented from being removed from the second end 624 of the body 620 by a radially inward shoulder of the body 620. The first end 622 of the body 620 may include a first portion 621a having a greater inner diameter than a second portion 621b of the first end 622. The first insulator 660 includes a first portion 662 that is press fit into the first portion 621a of the first end 622. The first portion 662 has an outer diameter that is greater than the inner diameter of the second portion 621b of the first end 622 such that the first portion 662 of the first insulator 660 cannot move beyond the first portion 621a of the body 620 in a direction toward the second end 624 of the body 620.

The external pin 650 includes a first end 652 configured to be coupled with a set screw port 29 associated with the input port 18 of the cable tap device 10 and a second end 654 having a bore 655 configured to receive a center conductor 94 of the coaxial cable connector 90. The second end 654 of the external pin 650 is configured to be received in a through bore 663 of the second insulator 661. The through bore 663 of the second insulator 661 permits the center conductor 94 to pass there through into the bore 655 of the external pin 650. The bore 663 includes a neck portion 665 having an inner diameter that is less than an outer diameter of the second end 654 of the external pin 650 such that the external pin 650 can be inserted into and removed from the second insulator 661 from the first end 622 of the body 620, but is prevented from being removed from the second end 624 of the body 620.

The external pin 650 comprises a conductive material configured to provide electrical connectivity with set screw port 29. The center conductor 94 can be a center conductor of a coaxial cable or a conductive pin of the coaxial cable connector 90. The bore 655 may have an inner diameter that is less than an outer diameter of the center conductor 94, and the second end 654 may include longitudinal slots (not shown) that permit the second end 654 to be urged radially outward to receive and retain the center conductor 94.

The first end 652 of the external pin 650 includes a plurality of fingers 652a configured to be inserted into the set screw port 29. The external pin 650 includes a middle portion 656 between the first end 652 and the second end 654 in the longitudinal direction X, as shown in FIG. 14. The middle portion 656 extends through a central through bore 666 of the first insulator 660. The middle portion 656 has an outer surface that may have an interference fit or friction fit relationship with an inner surface of the through bore 666 of the first insulator such that the external pin 650 is not movable relative to the first insulator in the absence of an axial force.

The middle portion 656 also includes a shoulder portion 669 proximate the second end 654 of the external pin 650. The shoulder portion 669 has an outer diameter that is greater than an inner diameter of the through bore 663 of the second insulator 661 to prevent the external pin 650 from passing through the through bore 663 of the second insulator 661. The shoulder portion 669 includes a surface 669a that faces the second insulator 661.

An internal pin 667 is disposed in the external pin 650. The internal pin 667 includes an enlarged head portion 667a at a forward end and an elongated shaft portion 667b that extends from the enlarged head portion 667a to an opposite rear end. As shown in FIG. 14, in their respective rest positions, the outer circumference of the enlarged head portion 667a is greater than an opening formed by the fingers 652a of the external pin 650. However, the internal pin 667 can be inserted into the external pin 650 by inserting the elongated shaft portion 667b into the opening formed by the fingers 652a and pushing the enlarged head portion 667a through the opening formed by the fingers 652a while expanding the fingers in a radially outward direction.

As shown in FIG. 15, when the adapter 600 is threaded into the input port 18, there is no electrical connection between the adapter 600 and the input port 18. As shown in FIG. 16, when a connector 90 is coupled with the adapter 600, for example, by threadedly coupling the connector 90 with the adapter 600, the center conductor 94 engages the rear end of the shaft 667b of the internal pin 667 and pushes the internal pin 667 in a forward direction. The internal pin 667 is moved forwardly to a contact position where the enlarged head portion 667a engages the flexible fingers 652a, which expands the flexible fingers 652a of the external pin 650 radially outward to provide electrical contact between the external pin 650 and the set screw port 29. Inner surfaces of the flexible fingers 652a may include notches 656a configured to receive the enlarged head portion 667a in the contact position to provide tactile feedback to a technician and to increase the force required to remove the enlarged head portion 667a from the contact position.

While this invention has been described in terms of several preferred embodiments, there are alteration, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A tap adapter configured to removably couple a coaxial cable connector with a cable tap, the adapter comprising:
a body;
a nut extending about and arranged coaxially with the body;
a retaining ring disposed radially between the body and the nut, the retaining ring being configured to couple the body with the nut;
a collet disposed in the body; and
an insulator disposed in the body and configured to receive a portion of the collet;
wherein the nut includes a first end configured to receive a coaxial cable connector and wherein the body is configured to extend from a second end of the nut;
wherein the collet has a first end configured to receive a center conductor of a cable terminated by the coaxial cable connector and a second end that includes an electrical contact member configured to be coupled with a port of a cable tap;
wherein the collet is configured to provide an electrical connection between the center conductor and the port of the cable tap;
wherein the electrical contact member includes a flexible contact member configured to be biasingly urged into contact with the port of the cable tap
wherein the insulator is configured to electrically insulate the collet relative to the body;
wherein the body and the retaining ring comprise a conductive material configured to provide electrical grounding between the coaxial cable connector and the cable tap;
wherein the nut is free to rotate relative to the body and is free to slide axially relative to the body as limited by the retaining ring; and
wherein the tap adapter permits the coaxial cable connector to be removed from the tap adapter while the tap adapter remains mechanically coupled with the cable tap and the second end of the collet remains mechanically and electrically coupled with the port.

2. A tap adapter configured to removably couple a coaxial cable connector with a cable tap, the adapter comprising:
a body;
a nut extending about and arranged coaxially with the body;
a retaining ring disposed radially between the body and the nut, the retaining ring being configured to couple the body with the nut; and
a collet disposed in the body;
wherein the nut includes a first end configured to receive a coaxial cable connector and wherein the body is configured to extend from a second end of the nut;
wherein the collet has a first end configured to receive a center conductor of a cable terminated by the coaxial cable connector and a second end configured to be coupled with a port of a cable tap;
wherein the collet is configured to provide an electrical connection between the center conductor and the port of the cable tap;
wherein the collet is electrically insulated from the body;
wherein the nut is free to rotate relative to the body and is free to slide axially relative to the body as limited by the retaining ring; and
wherein the tap adapter permits the coaxial cable connector to be removed from the tap adapter while the tap adapter remains mechanically coupled with the cable tap and the second end of the collet remains mechanically and electrically coupled with the port.

3. The adapter of claim 2, wherein the second end of the collet includes an electrical contact member configured to be coupled with the port of the cable tap.

4. The adapter of claim 3, wherein the electrical contact member is a flexible contact member.

5. The adapter of claim 4, wherein the electrical contact member is configured to be biasingly urged into contact with the port of the cable tap.

6. The adapter of claim 2, further comprising an insulator disposed in the body and configured to receive a portion of the collet,
wherein the insulator is configured to electrically insulate the collet relative to the body.

7. The adapter of claim 2, wherein the body and the retaining ring comprise a conductive material configured to provide electrical grounding between the coaxial cable connector and the cable tap.

8. The adapter of claim 7, wherein the swivel nut comprises a conductive material.

9. The adapter of claim 2, wherein the electrical contact member is a threaded contact member configured to be threadedly coupled with the port of the cable tap.

10. The adapter of claim 9, wherein the body is configured to be threadedly coupled with the cable tap, and
wherein a pitch of threads of the body is different than a pitch of threads of the electrical contact member.

11. The adapter of claim 10, wherein the collet is configured to slide relative to the body such that electrical contact member of the collet is configured to be threadedly coupled with the port of the cable tap when body is threadedly coupled with the cable tap despite the different pitches of the threads of the body and the threads of the electrical contact member.

12. A tap adapter configured to removably couple a coaxial cable connector with a cable tap, the adapter comprising:
a body;
a nut extending about the body;
a retaining ring configured to couple the body with the nut; and
a collet disposed in the body;
wherein the nut includes a first end configured to receive a coaxial cable connector;
wherein the collet has a first end configured to receive a center conductor of a cable terminated by the coaxial cable connector and a second end configured to be coupled with a port of a cable tap;
wherein the collet is configured to provide an electrical connection between the center conductor and the port of the cable tap;
wherein the nut is configured to rotate relative to the body and to slide axially relative to the body as limited by the retaining ring; and
wherein the tap adapter permits the coaxial cable connector to be removed from the tap adapter while the tap adapter remains mechanically coupled with the cable tap and the second end of the collet remains mechanically and electrically coupled with the port.

13. The adapter of claim 12, wherein the second end of the collet includes an electrical contact member configured to be coupled with the port of the cable tap.

14. The adapter of claim 13, wherein the electrical contact member is a flexible contact member.

15. The adapter of claim 14, wherein the electrical contact member is configured to be biasingly urged into contact with the port of the cable tap.

16. The adapter of claim 12, further comprising an insulator disposed in the body and configured to receive a portion of the collet,
wherein the insulator is configured to electrically insulate the collet relative to the body.

17. The adapter of claim 12, wherein the body and the retaining ring comprise a conductive material configured to provide electrical grounding between the coaxial cable connector and the cable tap.

18. The adapter of claim 17, wherein the swivel nut comprises a conductive material.

19. The adapter of claim 12, wherein the electrical contact member is a threaded contact member configured to be threadedly coupled with the port of the cable tap.

20. The adapter of claim 19, wherein the body is configured to be threadedly coupled with the cable tap, and
wherein a pitch of threads of the body is different than a pitch of threads of the electrical contact member.

21. The adapter of claim 20, wherein the collet is configured to slide relative to the body such that electrical contact member of the collet is configured to be threadedly coupled with the port of the cable tap when body is threadedly coupled with the cable tap despite the different pitches of the threads of the body and the threads of the electrical contact member.
